(19) United States
(12) Patent Application Publication
(10) Pub. No.: US 2014/0294452 A1
(43) Pub. Date: Oct. 2, 2014

(54) IMAGE FORMING APPARATUS

(71) Applicant: Fuji Xerox Co., Ltd., Tokyo (JP)

(72) Inventor: Kazuyuki YAGATA, Kanagawa (JP)

(73) Assignee: Fuji Xerox Co., Ltd., Tokyo (JP)

(21) Appl. No.: 14/015,127

(22) Filed: Aug. 30, 2013

(30) Foreign Application Priority Data
Mar. 26, 2013 (JP) 2013-063912

(51) Int. Cl. G03G 15/01

(52) U.S. Cl. CPC G03G 15/1615
USPC 399/302

(57) ABSTRACT

An image forming apparatus includes an intermediate transfer body onto which developer images are transferred, a second transfer unit that transfers the developer images on the intermediate transfer body onto a recording medium, support members including first and second support members, and a contact member. The first support member faces the second transfer unit with the intermediate transfer body therebetween and causes the recording medium to be nipped between the intermediate transfer body and the second transfer unit. The second support member is disposed upstream of the first support member in a rotation direction of the intermediate transfer body and outwardly stretches the intermediate transfer body. The contact member contacts a trailing end of the recording medium in a transport direction when the recording medium is nipped. The trailing end of the recording medium moves along the contact member toward the intermediate transfer body when the recording medium is nipped.

### CROSS-REFERENCE TO RELATED APPLICATIONS

This application is based on and claims priority under 35 USC 119 from Japanese Patent Application No. 2013-063912 filed Mar. 26, 2013.

### BACKGROUND

(i) Technical Field

The present invention relates to an image forming apparatus.

(ii) Related Art

Tandem color printers, which are an example of image forming apparatuses, include plural image forming units for forming toner images (an example of developer images) of respective colors, such as yellow (Y), magenta (M), cyan (C), and black (K). Each image forming unit includes a charging device, a developing device, and a photoconductor drum (an example of an image carrier).

The toner images of the respective colors formed by the respective image forming units are transferred onto an intermediate transfer belt (an example of an intermediate transfer body) in a superimposed manner by first transfer rollers (first transfer process). Then, the toner images on the intermediate transfer belt are transferred onto a sheet of paper (an example of a recording medium) by a second transfer roller (second transfer process).

### SUMMARY

According to an aspect of the invention, there is provided an image forming apparatus including an intermediate transfer body that has an endless structure and onto which plural developer images of respective colors are transferred in a superimposed manner by a first transfer unit; a second transfer unit that transfers the developer images that have been transferred onto the intermediate transfer body onto a recording medium; plural support members that support the intermediate transfer body such that the intermediate transfer body rotates in a circumferential direction and that includes a first support member and a second support member, the first support member being positioned so as to face the second transfer unit with the intermediate transfer body interposed therebetween and causing the recording medium to be nipped between the intermediate transfer body and the second transfer unit, and the second support member being disposed upstream of the first support member in a rotation direction of the intermediate transfer body and supporting the intermediate transfer body so as to outwardly stretch the intermediate transfer body; and a contact member configured to contact a trailing end of the recording medium in a transport direction of the recording medium when the recording medium is nipped between the second transfer unit and the intermediate transfer body. The trailing end of the recording medium in the transport direction moves along the contact member toward the intermediate transfer body when the recording medium is nipped between the second transfer unit and the intermediate transfer body.

### BRIEF DESCRIPTION OF THE DRAWINGS

An exemplary embodiment of the present invention will be described in detail based on the following figures, wherein:

FIG. 1 illustrates an example of an image forming apparatus according to an exemplary embodiment of the present invention;

FIG. 2 illustrates a part of the image forming apparatus according to the exemplary embodiment of the present invention;

FIG. 3 illustrates the manner in which a sheet of paper moves when the sheet of paper is nipped between a transfer roller and a backup roller in the image forming apparatus according to the exemplary embodiment of the present invention;

FIG. 4 illustrates the manner in which the sheet of paper moves from the position illustrated in FIG. 3 when the sheet of paper is nipped between the transfer roller and the backup roller in the image forming apparatus according to the exemplary embodiment of the present invention;

FIG. 5 illustrates the manner in which the sheet of paper moves from the position illustrated in FIG. 4 when the sheet of paper is nipped between the transfer roller and the backup roller in the image forming apparatus according to the exemplary embodiment of the present invention; and

FIG. 6 illustrates a modification of a part of the image forming apparatus according to the exemplary embodiment of the present invention.

### DETAILED DESCRIPTION

An exemplary embodiment of the present invention will now be described in detail with reference to the drawings. In the diagrams for describing the exemplary embodiment, components having the same structure are basically denoted by the same reference numerals, and redundant descriptions thereof will thus be omitted.

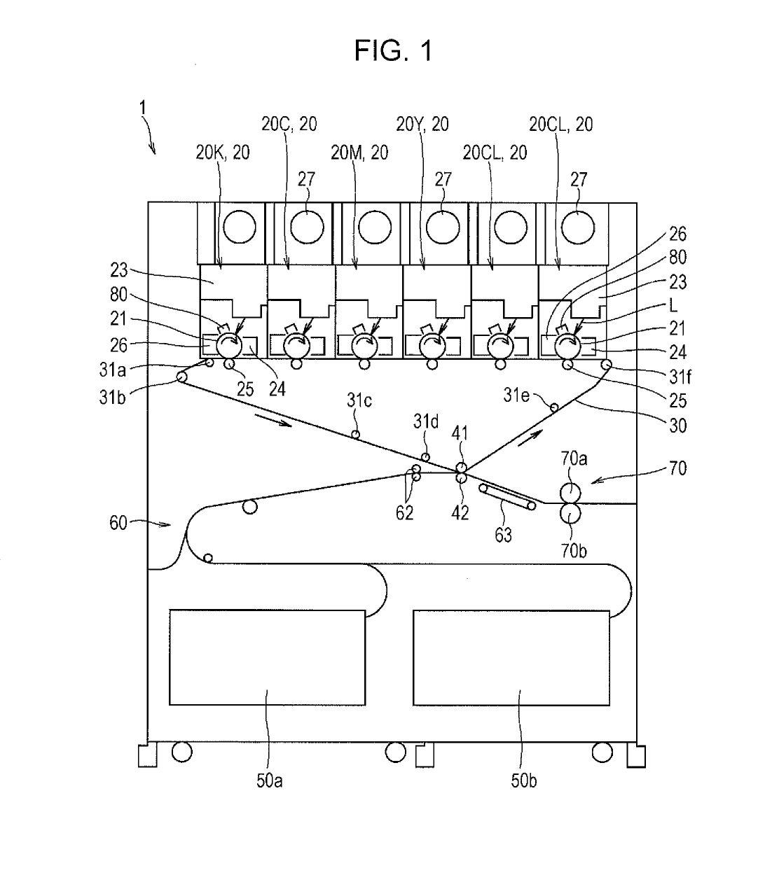

FIG. 1 illustrates an image forming apparatus 1 according to an exemplary embodiment of the present invention.

The image forming apparatus 1 according to the present exemplary embodiment is, for example, a tandem color printer, and includes plural image forming units 20; an intermediate transfer belt (an example of an intermediate transfer body) 30; a pair of rollers including a backup roller (an example of a first support member, which is one of support members) 41 and a second transfer roller (an example of a second transfer unit) 42; sheet feed trays 50a and 50b; a sheet transport system 60; and a fixing device 70.

The image forming units 20 include four color image forming units 20Y, 20M, 20C, and 20K for forming, for example, yellow, magenta, cyan, and black toner images, and clear-color image forming units 20CL and 20CL for transferring, for example, toner images of clear colors. The image forming units 20 transfer toner images formed in accordance with image information of the respective colors onto the intermediate transfer belt 30 in a first transfer process.

The six image forming units 20CL, 20CL, 20Y, 20M, 20C, and 20K corresponding to a clear color, another clear color, yellow, magenta, cyan, and black, respectively, are arranged in that order in a rotation direction of the intermediate transfer belt 30. Light-color image forming units that transfer toner images of light colors, such as light yellow, light magenta, light cyan, or light black, may be provided instead of the clear-color image forming units 20CL and 20CL. Alternatively, a clear-color image forming unit 20CL and a light-color image forming unit may be both arranged next to each other.

Each image forming unit 20 includes a photoconductor drum 21, a charging device 80, an exposure device (an example of an exposure unit) 23, a developing device (an example of a developing unit) 24, a first transfer roller (an example of a first transfer unit) 25, and a drum cleaner 26. The charging device 80 charges the surface of the photoconductor drum 21 to a predetermined potential. The exposure device 23 forms an electrostatic latent image by irradiating the charged photoconductor drum 21 with a laser beam L. The developing device 24 forms a toner image by developing the electrostatic latent image formed on the photoconductor drum 21 by the exposure device 23. The first transfer roller 25 transfers the toner image on the photoconductor drum 21 onto the intermediate transfer belt 30 in a first transfer section. The drum cleaner 26 removes residual toner, paper dust, etc., from the surface of the photoconductor drum 21 after the toner image has been transferred. A toner cartridge 27, which supplies developer to the corresponding developing device 24, is disposed above each image forming unit 20.

In each image forming unit 20, the first transfer roller 25 is arranged so that the intermediate transfer belt 30 is nipped between itself and the photoconductor drum 21. A transfer bias voltage having a polarity opposite to the charge polarity of the toner is applied to the first transfer roller 25, so that an electric field is formed between the photoconductor drum 21 and the first transfer roller 25. Accordingly, the toner image that is charged on the photoconductor drum 21 is transferred onto the intermediate transfer belt 30 by the Coulomb force.

The toner images of the respective colors formed by the image forming units 20 are successively transferred onto the intermediate transfer belt 30 in the first transfer process and carried by the intermediate transfer belt 30. The intermediate transfer belt 30 is an endless belt that is wrapped around plural support rollers (an example of plural support members) 31a to 31f and the backup roller 41. In the first transfer process, the toner images of the respective colors formed by the image forming units 20CL, 20CL, 20Y, 20M, 20C, and 20K are transferred onto the intermediate transfer belt 30 in a superimposed manner while the intermediate transfer belt 30 rotates counterclockwise.

The backup roller 41 and the second transfer roller 42 form a mechanical unit for forming a full-color image by simultaneously transferring the toner images, which have been transferred onto the intermediate transfer belt 30 in a superimposed manner, onto a sheet of paper (an example of a recording medium) or the like (second transfer process). The backup roller 41 and the second transfer roller 42 face each other with the intermediate transfer belt 30 interposed therebetween. A section in which the backup roller 41 and the second transfer roller 42 face each other is defined as a second transfer nip section N.

The backup roller 41 is rotatably arranged on the back side of the intermediate transfer belt 30. The second transfer roller 42 is rotatably arranged so as to face the surface of the intermediate transfer belt 30 onto which the toner images are transferred. The backup roller 41 and the second transfer roller 42 are arranged so that rotation axes thereof, which extend in a direction perpendicular to FIG. 1, are parallel to each other.

The toner images on the intermediate transfer belt 30 are transferred onto the sheet of paper by applying a voltage having the same polarity as the charge polarity of the toner to the backup roller 41 or applying a voltage having a polarity opposite to the charge polarity of the toner to the second transfer roller 42. Accordingly, a transfer electric field is formed between the backup roller 41 and the second transfer roller 42, and the unfixed toner images carried by the intermediate transfer belt 30 are transferred onto the sheet of paper.

The sheet feed trays 50a and 50b contain, for example, sheets of paper having different sizes and thicknesses. A sheet of paper is fed from one of the sheet feed trays 50a and 50b by a pickup roller (not shown) of the sheet transport system 60. Then, the sheet of paper is guided to the second transfer nip section N at a timing controller by a pair of registration rollers 62 of the sheet transport system 60, and the toner images are transferred onto the sheet of paper. Then, the sheet of paper is transported to the fixing device 70 by a transport belt 63 of the sheet transport system 60.

The fixing device 70 fixes the unfixed toner images that have been transferred onto the sheet of paper in the second transfer process to the sheet of paper by applying heat and pressure. The fixing device 70 includes a heating roller 70a and a pressing roller 70b that faces the heating roller 70a.

After the second transfer process, the sheet of paper is transported to a fixing nip section between the heating roller 70a and the pressing roller 70b, and is ejected while being nipped between the heating roller 70a and the pressing roller 70b. At this time, the sheet of paper is heated by the heating roller 70a and pressed by the pressing roller 70b, so that the toner images are fixed to the sheet of paper. The sheet of paper that has passed through the fixing device 70 is transported to an ejection roller (not shown) by a transport belt (not shown), and is ejected to the outside of the image forming apparatus 1.

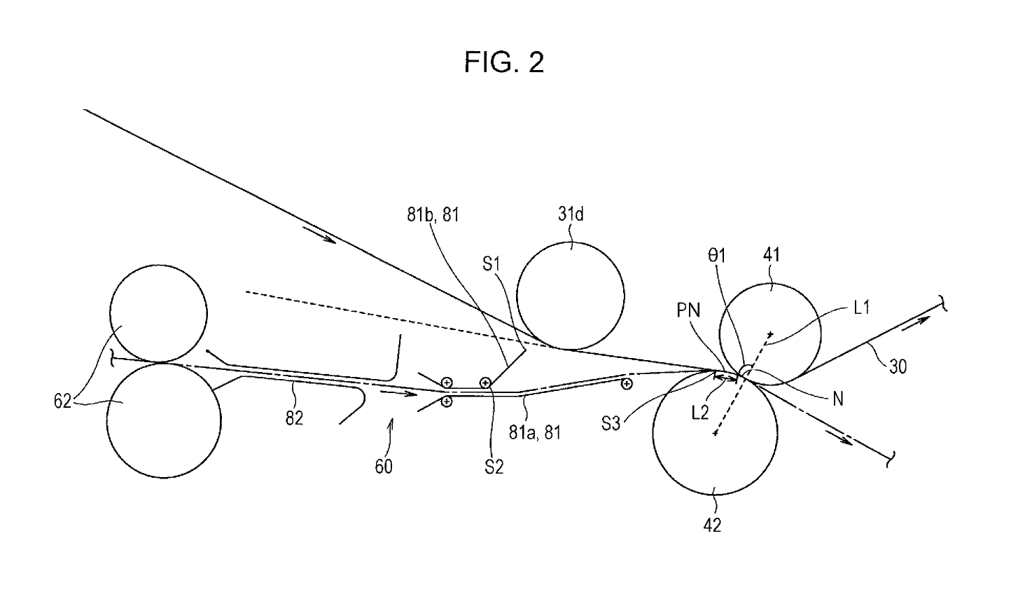

FIG. 2 illustrates a part of the image forming apparatus 1 illustrated in FIG. 1.

As illustrated in FIG. 2, an angle θ1 between a segment L1 connecting the rotation centers of the backup roller 41 and the second transfer roller 42 and a portion of the intermediate transfer belt 30 between the support roller 31d and the backup roller 41 at the back side of the intermediate transfer belt 30 is set so as to be larger than 90°. The support roller 31d, which is an example of a second support member included in plural support members, is disposed upstream of the backup roller 41 (more specifically, upstream of the backup roller 41 in the rotation direction of the intermediate transfer belt 30).

Accordingly, the intermediate transfer belt 30 is slightly wrapped around the second transfer roller 42. The section in which the intermediate transfer belt 30 is wrapped around the second transfer roller 42 is hereinafter referred to as a “pre-nip section PN”. Before reaching the second transfer nip section N, the sheet of paper is nipped between the intermediate transfer belt 30 and the second transfer roller 42 in the pre-nip section PN with a force weaker than that applied in the second transfer nip section N.

Thus, the toner images on the intermediate transfer belt 30 are transferred onto the sheet of paper by a force that increases stepwise when the sheet passes through the pre-nip section PN and the second transfer nip section N. Therefore, compared to the case in which the pre-nip section PN is not formed, scattering of the toner during the transfer of the toner images may be suppressed and image defects due to the scattering of the toner may be reduced. Although the length L2 of the pre-nip section PN is about 3 mm in the present exemplary embodiment, the length L2 may be freely set.

As illustrated, two guide members 81 and 82 are disposed between the registration rollers 62 of the sheet transport system 60 and the second transfer nip section N. Each of the guide members 81 and 82 includes a pair of guide pieces for supporting the sheet of paper transported by the sheet transport system 60 at both sides thereof.

The sheet of paper ejected from the registration rollers 62 is transported to the guide member 81 adjacent to the second transfer nip section N through the guide member 82 adjacent to the registration rollers 62, and is guided to the second transfer nip section N by the guide member 81.

The guide member 81 controls the orientation of the sheet of paper so that the leading end of the sheet of paper that is being transport comes into contact with the intermediate transfer belt 30 at a position in front of the pre-nip section PN (about 10 mm in front of the pre-nip section PN in the present exemplary embodiment).

The guide member 81 may be disposed in front of the pre-nip section PN so as to be spaced from the pre-nip section PN by a distance long enough to suppress banding, which will be described below.

A first guide piece 81a, which is one of the guide pieces of the guide member 81 that contacts the sheet of paper, extends toward the pre-nip section PN and regulates a transport direction of the sheet of paper so that the sheet of paper comes into contact with the intermediate transfer belt 30 at a position in front of the pre-nip section PN.

Accordingly, the air between the sheet of paper and the intermediate transfer belt 30 is smoothly removed when the sheet of paper enters the pre-nip section PN, and image defects due to displacements of toner particles on the intermediate transfer belt 30 caused by air turbulence may be reduced.

Since the pre-nip section PN is formed as described above, the backup roller 41 and the second transfer roller 42 operate in conjunction with each other so as to nip the sheet of paper in the pre-nip section PN while pressing the sheet of paper against the intermediate transfer belt 30.

Accordingly, without any countermeasures, the sheet of paper hits the intermediate transfer belt 30 immediately after being released from the guide member 81, and the toner images on the intermediate transfer belt 30 are degraded. This phenomenon is called banding, which leads to image defects.

In particular, when a thick sheet of paper having a weight of, for example, 300 grams per square meter (GSM) is subjected to a high-speed image forming operation in which the transport speed of the sheet of paper is, for example, about 440 mm/sec, the intermediate transfer belt 30 is hit with a large force since the sheet of paper is strong. As a result, the level of image defects due to banding increases.

Accordingly, in the image forming apparatus 1 of the present exemplary embodiment, the support roller 31d, which is disposed upstream of the backup roller 41 in the rotation direction of the intermediate transfer belt 30, supports the intermediate transfer belt 30 so as to outwardly stretch the intermediate transfer belt 30, as illustrated in FIG. 2.

A second guide piece 81b (an example of a contact member), which is the other one of the guide pieces of the guide member 81 that is adjacent to the intermediate transfer belt 30, includes a portion that faces the first guide piece 81a. In a region downstream of this portion in the transport direction of the sheet of paper, the second guide piece 81b extends toward the intermediate transfer belt 30 along the transport direction of the sheet of paper so that the trailing end of the sheet of paper comes into contact with the second guide piece 81b when the sheet of paper is pressed against the intermediate transfer belt 30.

Referring to FIG. 2, an intermediate-transfer-belt-30 side end of the guide piece 81b is located near an extension plane (shown by the broken line in FIG. 2) of the portion of the intermediate transfer belt 30 between the backup roller 41 and the second support member 31d at the upstream side in the rotation direction of the intermediate transfer belt 30.

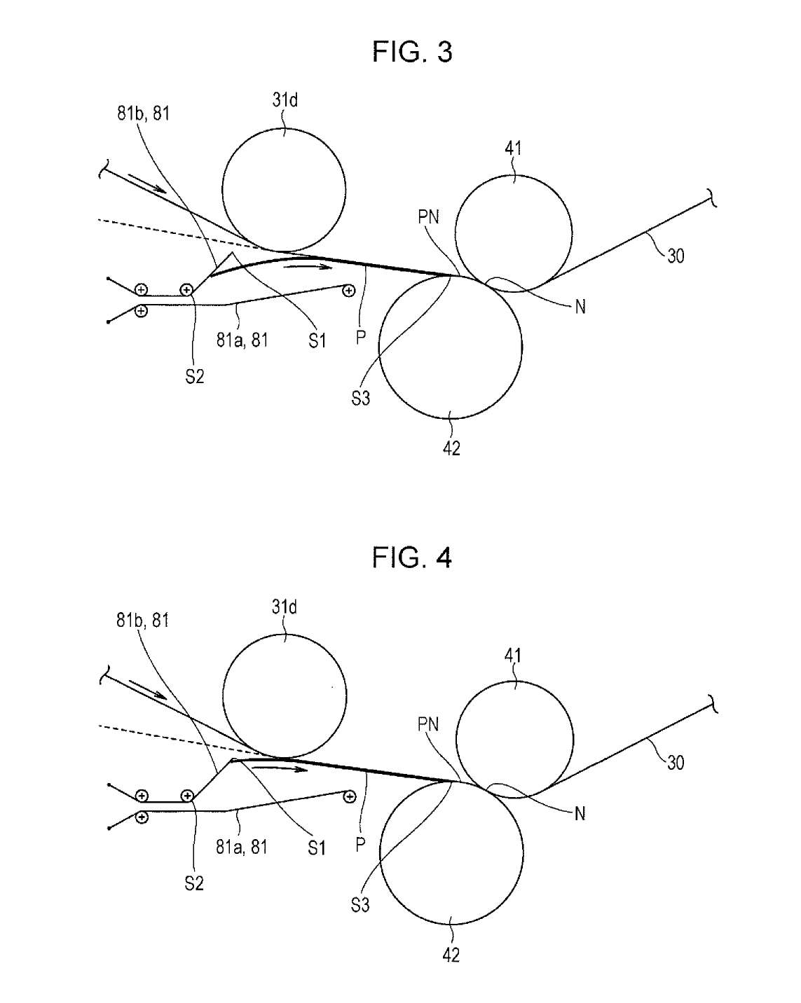

Accordingly, when the sheet of paper P enters the pre-nip section PN, in which the intermediate transfer belt 30 is slightly wrapped around the second transfer roller 42, while being pressed against the intermediate transfer belt 30, the trailing end of the sheet of paper P gradually moves along the guide piece 81b toward the intermediate transfer belt 30, as illustrated in FIG. 3.

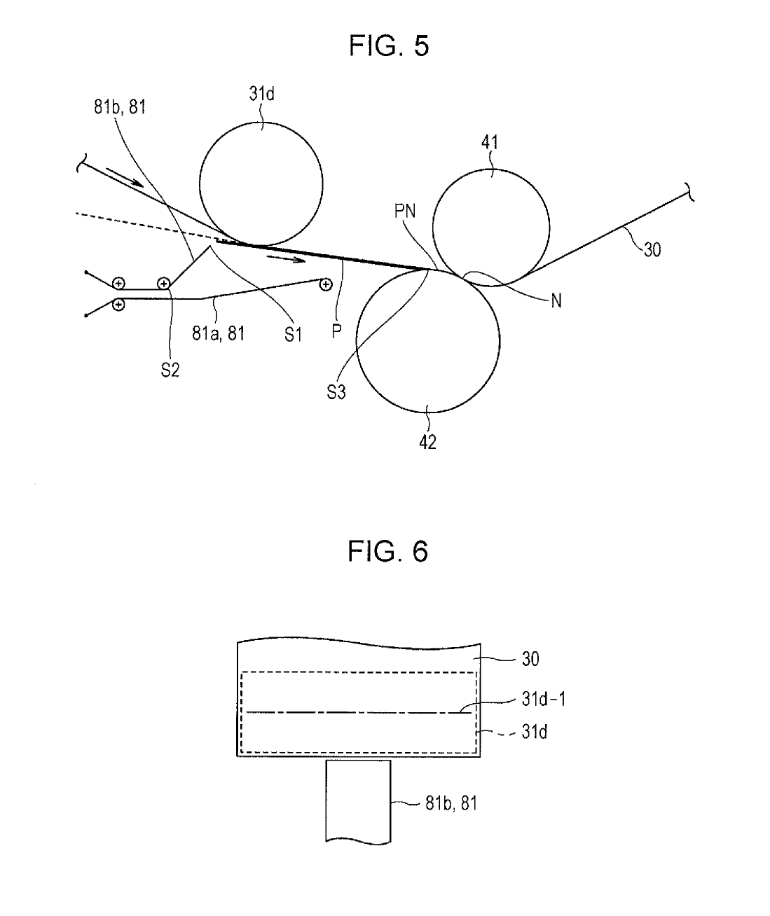

When the trailing end of the sheet of paper P reaches the intermediate-transfer-belt-30 side end of the guide piece 81b as illustrated in FIG. 4, the distance from the trailing end of the sheet of paper P to the above-described extension plane, that is, the distance by which the trailing end of the sheet of paper P moves to the position illustrated in FIG. 5 after being released from the guide piece 81b, is very small.

Therefore, the force with which the sheet of paper P hits the intermediate transfer belt 30 when the trailing end of the sheet of paper P moves from the position illustrated in FIG. 4 to the position illustrated in FIG. 5 is small, and impact on the intermediate transfer belt 30 is smaller than that in the case where the structure of the present exemplary embodiment is not provided. Accordingly, the occurrence of banding is smaller than that in the case where the structure of the present exemplary embodiment is not provided, and degradation of the toner images on the intermediate transfer belt 30 may be suppressed. As a result, image defects may be reduced.

The intermediate-transfer-belt-30 side end of the guide piece 81b may be located at a position on the above-described extension plane (shown by the broken lines in FIGS. 2 to 5) or a position closer to the intermediate transfer belt 30 than the extension plane. In such a case, the sheet of paper P reaches the position illustrated in FIG. 5 at or before the time when the trailing end of the sheet of paper P leaves the guide piece 81b. In other words, in this case, the distance by which the trailing end of the sheet of paper P freely moves to the position illustrated in FIG. 5 after being released from the guide piece 81b is eliminated.

Accordingly, the force with which the sheet of paper P hits the intermediate transfer belt 30 when the trailing end of the sheet of paper P reaches the position illustrated in FIG. 5 is reduced. As a result, impact on the intermediate transfer belt 30 is further reduced, and the image defects due to banding may be more reliably reduced.

As illustrated, the intermediate-transfer-belt-30 side end of the guide piece 81b faces the second support member 31d. Accordingly, the trailing end of the sheet of paper P comes into contact with the intermediate transfer belt 30 in a region near the position at which the intermediate transfer belt 30 is wrapped around the second support member 31d. Therefore, the impact on the intermediate transfer belt 30 may be absorbed by the second support member 31d. Thus, transmission of the impact on the intermediate transfer belt 30 to the first transfer rollers 25 may be suppressed.

The distance between the intermediate-transfer-belt-3Q side end of the guide piece 81b and the intermediate transfer belt 30 may be smaller than the length in the transport direction of a portion of the sheet of paper P in a region in which no image is formed (non-image region) at the trailing end of the sheet of paper P in the transport direction.

In this case, the impact applied to the intermediate transfer belt 30 by the sheet of paper P may be further reduced.

FIG. 6 illustrates a part of the apparatus viewed in a direction in which a rotation axis 31d-1 of the second support member 31d is viewed from the front. As illustrated in FIG. 6, the guide piece 81b may be shaped so as to cover at least a central section, in an axial direction of the apparatus, of a region in which the sheet of paper P is transported.

If the guide piece 81b is provided only at a first end in the axial direction of the apparatus and is not provided at a second end, banding occurs at the second end. However, when the guide piece 81b is shaped as described above, banding may be suppressed not only in the central section but also at both ends, and the impact applied to the intermediate transfer belt 30 by the sheet of paper P may be reduced.

The guide piece 81b may be made of a metal and grounded. In this case, charging of the guide piece 81b is suppressed when the sheet of paper P slides along the guide piece 81b. Accordingly, degradation of the toner images on the intermediate transfer belt 30 and scattering of the toner due to electric charges on the guide piece 81b may be suppressed.

Referring to FIG. 2, an intermediate-transfer-belt-30 side end and the other end of the portion of the guide piece 81b that extends toward the intermediate transfer belt 30 are defined as points S1 and S2, respectively, and the start position of the pre-nip section PN is defined as point S3. The result of examinations conducted by the present inventor shows that the trailing end of the sheet of paper P moves along the guide piece 81b to the point S1 (intermediate-transfer-belt-30 side end of the guide piece 81b) when the angle between the segment connecting the points S1 and S2 and the segment connecting the points S2 and S3 is 60° or less.

However, this angle is not uniquely defined, and varies depending on various factors, such as the thickness and size of the sheet of paper, the transport speed of the sheet of paper, and the distance between the points S2 and S3.

Although the sheet of paper is used as a recording medium in the above-described exemplary embodiment, the recording medium is not limited to this. For example, a film, a postcard, etc., on which an image may be formed may instead be used.

Although the present invention is applied to a color printer in the above-described description, the present invention may instead be applied to other image forming apparatuses such as a color copier, a facsimile machine, or an image forming apparatus having the functions of both a color copier and a facsimile machine.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an intermediate transfer body that has an endless structure and onto which a plurality of developer images of respective colors are transferred in a superimposed manner by a first transfer unit;
a second transfer unit that transfers the developer images that have been transferred onto the intermediate transfer body onto a recording medium;
a plurality of support members that support the intermediate transfer body such that the intermediate transfer body rotates in a circumferential direction and that includes a first support member and a second support member, the first support member being positioned so as to face the second transfer unit with the intermediate transfer body interposed therebetween and causing the recording medium to be nipped between the intermediate transfer body and the second transfer unit, and the second support member being disposed upstream of the first support member in a rotation direction of the intermediate transfer body and supporting the intermediate transfer body so as to outwardly stretch the intermediate transfer body; and
a contact member configured to contact a trailing end of the recording medium in a transport direction of the recording medium when the recording medium is nipped between the second transfer unit and the intermediate transfer body,
wherein the trailing end of the recording medium in the transport direction moves along the contact member toward the intermediate transfer body when the recording medium is nipped between the second transfer unit and the intermediate transfer body.

2. An image forming apparatus comprising:
an intermediate transfer body that has an endless structure and onto which a plurality of developer images of respective colors are transferred in a superimposed manner by a first transfer unit;
a second transfer unit that transfers the developer images that have been transferred onto the intermediate transfer body onto a recording medium;
a plurality of support members that support the intermediate transfer body such that the intermediate transfer body rotates in a circumferential direction and that includes a first support member and a second support member, the first support member being positioned so as to face the second transfer unit with the intermediate transfer body interposed therebetween and causing the recording medium to be nipped between the intermediate transfer body and the second transfer unit, and the second support member being disposed upstream of the first support member in a rotation direction of the intermediate transfer body and supporting the intermediate transfer body so as to outwardly stretch the intermediate transfer body; and
a contact member configured to contact a trailing end of the recording medium in a transport direction of the recording medium when the recording medium is nipped between the second transfer unit and the intermediate transfer body,
wherein an intermediate-transfer-body side end of the contact member is at a position on an extension plane of a portion of the intermediate transfer body between the first support member and the second support member at an upstream side in the rotation direction of the intermediate transfer body or a position closer to the intermediate transfer body than the extension plane.

3. The image forming apparatus according to claim 2, wherein the intermediate-transfer-body side end of the contact member faces the second support member.

4. The image forming apparatus according to claim 2, wherein a distance between the intermediate-transfer-body side end of the contact member and the intermediate transfer body is smaller than a length, in the transport direction of the recording medium, of a non-image region of the recording medium at the trailing end of the recording medium in the transport direction, the non-image region being a region in which no image is formed.

5. The image forming apparatus according to claim 3, wherein a distance between the intermediate-transfer-body side end of the contact member and the intermediate transfer body is smaller than a length, in the transport direction of the recording medium, of a non-image region of the recording medium at the trailing end of the recording medium in the transport direction, the non-image region being a region in which no image is formed.

6. The image forming apparatus according to claim 2, wherein the contact member covers at least a central section, in an axial direction of the apparatus, of a region in which the recording medium is transported.

7. The image forming apparatus according to claim 3, wherein the contact member covers at least a central section, in an axial direction of the apparatus, of a region in which the recording medium is transported.

8. The image forming apparatus according to claim 4, wherein the contact member covers at least a central section, in an axial direction of the apparatus, of a region in which the recording medium is transported.

9. The image forming apparatus according to claim 5, wherein the contact member covers at least a central section, in an axial direction of the apparatus, of a region in which the recording medium is transported.

10. The image forming apparatus according to claim 2, wherein the contact member is made of a metal and is grounded.

11. The image forming apparatus according to claim 3, wherein the contact member is made of a metal and is grounded.

12. The image forming apparatus according to claim 4, wherein the contact member is made of a metal and is grounded.

13. The image forming apparatus according to claim 5, wherein the contact member is made of a metal and is grounded.

14. The image forming apparatus according to claim 6, wherein the contact member is made of a metal and is grounded.

15. The image forming apparatus according to claim 7, wherein the contact member is made of a metal and is grounded.

16. The image forming apparatus according to claim 8, wherein the contact member is made of a metal and is grounded.

17. The image forming apparatus according to claim 9, wherein the contact member is made of a metal and is grounded.
